(19) United States
(12) Patent Application Publication
(10) Pub. No.: US 2007/0135136 A1
(43) Pub. Date: Jun. 14, 2007

(54) Method and apparatus for providing location information

(76) Inventor: Marc Ische, San Diego, CA (US)

Correspondence Address: QUALCOMM INCORPORATED, 5775 MOREHOUSE DR., SAN DIEGO, CA, 92121, US

(21) Appl. No.: 11/483,029

(22) Filed: Jul. 7, 2006

Related U.S. Application Data
(60) Provisional application No. 60/697,171, filed on Jul. 7, 2005.

(51) Int. Cl. H04Q 7/20

(52) U.S. Cl. 455/456.1

(57) ABSTRACT

Information known to the mobile station, such as but not limited to location, date, time, user preferences, etc. is combined with information gained from an application in progress, such as but not limited to an Internet web page, e-mail message, photograph application, or information directly input by the user. The user is then presented an intelligent list of location-based options to access.

### RELATED APPLICATIONS

The present application claims priority to provisional U.S. Application Ser. No. 60/697,171, entitled “GSM JMTS Handset Positioning Requirements,” filed Jul. 7, 2005, assigned to the assignee hereof and incorporated herein by reference.

### BACKGROUND

I. Field

The present invention relates generally to communication, and more specifically to techniques for providing location information.

II. Background

It is often desirable and sometimes necessary to know the location of a wireless device, for example, a cellular telephone, personal communication system (PCS), wireless laptop computer, etc., in a network. For example, a wireless user may utilize the wireless device to browse through a website and may click on location sensitive content. The web server may then query the network for the location of the wireless device. The network may initiate location processing with the wireless device in order to ascertain the location of the wireless device. The network would then return a location estimate for the wireless device to the web server, which may use this location estimate to provide appropriate content to the wireless user. There are many other scenarios in which knowledge of the location of the wireless device is useful or necessary. In the following description, the terms “location” and “position” are synonymous and are used interchangeably.

Therefore, while some wireless devices are configured to provide location based services such as data or messaging services, call routing, nearby points of interest, etc. based upon the location of the device, it would be useful to expand the positioning information options available to a user at the user's request. There is therefore a need in the art for techniques to effectively provide location information in connection with a wireless device.

### SUMMARY

Techniques for efficiently providing location information options are presented. By combining information known to the mobile station, such as but not limited to date, time, user preferences, contact list, etc., with information gained from an application in progress, such as but not limited to an Internet web page, e-mail message, photograph application, or information directly input by the user, the user is presented an intelligent list of location-based options.

### BRIEF DESCRIPTION OF THE DRAWINGS

The features and nature of the present invention will become more apparent from the detailed description set forth below when taken in conjunction with the drawings in which like reference characters identify correspondingly throughout.

FIG. 1 shows a wireless communication system; and

FIG. 2 shows a diagram of components included in a conventional mobile station.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

The location information techniques described herein may be used in the context of various wireless networks such as a Code Division Multiple Access (CDMA) network, a Time Division Multiple Access (TDMA) network, a Frequency Division Multiple Access (FDMA) network, an Orthogonal Frequency Division Multiple Access (OFDMA) network, a network supporting a combination of the aforementioned technologies, a network with wide area network (WAN) coverage as well as wireless local area network (WLAN) coverage, and so on. A CDMA network may implement one or more CDMA radio access technologies (RATs) such as Wideband CDMA (W-CDMA), cdma2000, and so on. cdma2000 covers IS-2000, IS-856, and IS-95 standards. A TDMA network may implement one or more TDMA RATs such as Global System for Mobile Communications (GSM), Digital Advanced Mobile Phone System (D-AMPS), and so on. D-AMPS covers IS-136 and IS-54. These various RATs and standards are known in the art. W-CDMA and GSM are described in documents from a consortium named “3rd Generation Partnership Project” (3GPP). cdma2000 is described in documents from a consortium named “3rd Generation Partnership Project 2” (3GPP2). 3GPP and 3GPP2 documents are publicly available.

The term “wireless device” or “wireless terminal” as used herein is also commonly referred to as a mobile station (MS), user equipment (UE), cellular telephone, personal communication system (PCS), wireless laptop computer, etc. The term wireless device is not to be limited to any particular apparatus.

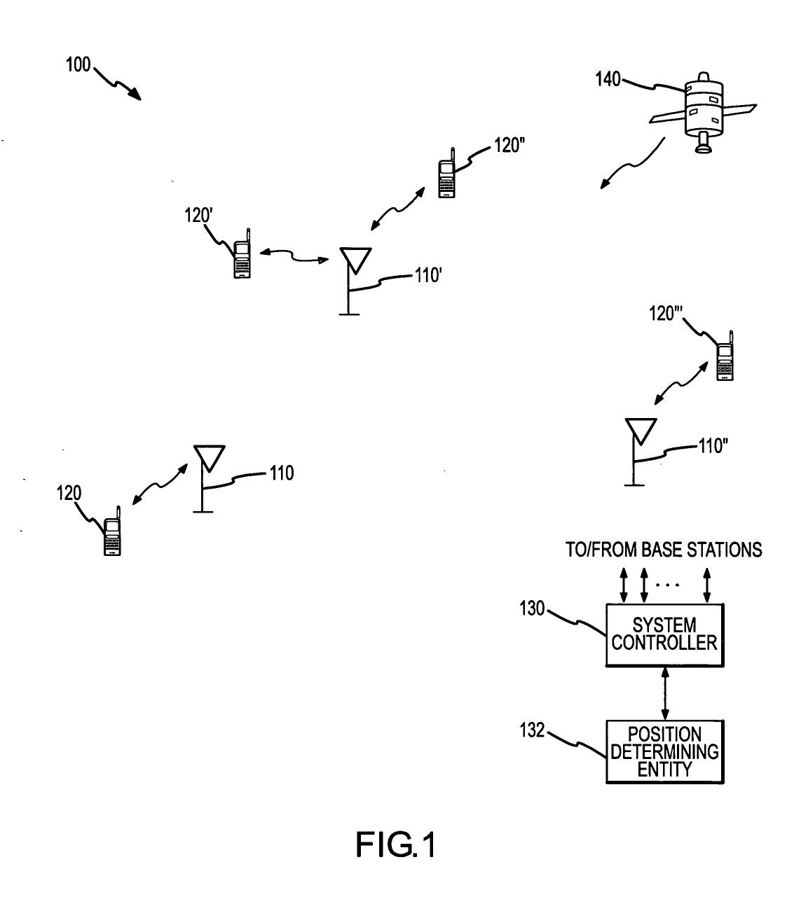

FIG. 1 shows a wireless multiple-access communication network 100 within which the methodology and apparatus may be implemented. Network 100 includes multiple base stations 110, with each base station providing communication coverage for a particular geographic area. A base station is generally a fixed station that communicates with the terminals, hereinafter referred to generically as mobile stations (MSs). A base station may also be called an access point, a Node B, a beacon, or some other terminology. The term “cell” can refer to a base station and/or its coverage area depending on the context in which the term is used. The base stations may have coverage areas of different sizes and shapes, which may be determined by various factors such as terrain, obstructions, and so on. To improve system capacity, a base station coverage area may be partitioned into multiple smaller areas. Each smaller area is served by a respective base transceiver subsystem (BTS). For simplicity, in the following description, the term “base station” generically refers to a fixed station that serves a sector as well as a fixed station that serves a cell.

A system controller 130 couples to base stations 110 and provides coordination and control for these base stations. System controller 130 may be a single network entity or a collection of network entities. For example, system controller 130 may include one or more of a Base Station Controller (BSC), a Mobile Switching Center (MSC), a Radio Network Controller (RNC), a Packet Data Serving Node (PDSN), and/or some other network entity. A Position Determining Entity (PDE) 132 supports position determination for the mobile stations 120. For example, PDE 132 may provide assistance data used by the mobile stations to determine position, in MS-based mode. PDE 132 may also compute position estimates for the mobile stations 120 based on ranging measurements provided by the mobile stations and/or the base stations, in MS-assisted mode.

Mobile stations 120 are typically dispersed throughout network 100, and each mobile station may be fixed or mobile. A mobile station 120 may also be called a terminal, an access terminal, user equipment, or some other terminology. Mobile station 120 may be a wireless device, a cellular telephone, a wireless modem, a wireless module, telemetry device, a personal digital assistant (PDA), laptop with wireless access, and so on. A mobile station 120 may communicate with zero, one, or multiple base stations on the forward and/or reverse links at any given moment. A mobile station 120 may also receive signals from satellites 140, which may be from a Global Positioning System (GPS), Galileo and/or other satellite positioning or communication systems, each referred to generally herein as a Satellite Positioning System (SPS). In general, a mobile station 120 may communicate directly with network 100 if good received signal quality can be achieved for both the forward and reverse links.

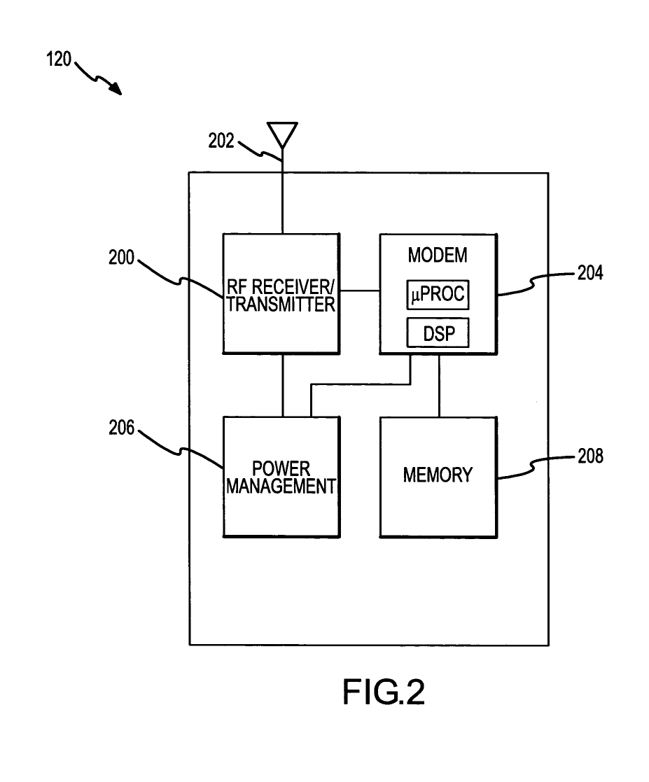

FIG. 2 shows a block diagram of basic components included in a conventional mobile station 120 having position location capability. Mobile station 120 includes a wireless communication transceiver 200 and associated antenna 202 capable of sending and receiving wireless communication signals as well as receiving SPS signals. Modem 204 includes the appropriate microprocessor(s) and digital signal processor(s) and other suitable hardware, such as but not limited to a correlator bank, for processing signals. Power management 206 controls power issues for various components of the mobile station 120. Memory 208 is coupled to modem 204 as necessary for implementing various modem processes. Mobile station 120 includes an appropriate user interface with alphanumeric keypad, display, microphone, speaker, etc.

It will be appreciated by those skilled in the art that mobile station 120 can include a variety of components. The methodology described herein may be implemented by suitable instructions operating on a microprocessor and memory of mobile station 120, but is certainly not limited to such an implementation.

A location estimate for a mobile station 120 may be obtained using a UE-based, UE-assisted, or network-based positioning mode. Positioning refers to a functionality that detects or determines a geographical location of a target mobile station. For the UE-based mode, the location of the mobile station is determined by the mobile station, possibly with assistance data from a serving mobile location center (SMLC). For the UE-assisted mode, the location of the mobile station is determined by the SMLC with assistance (e.g., measurements) from the mobile station. For the network-based mode, the location of the mobile station is determined based on information obtained by or already known to the serving network without any special assistance from the mobile station.

The UE-based and UE-assisted modes may utilize various positioning methods such as Global Positioning System (GPS), assisted GPS (A-GPS), hybrid, advanced forward link trilateration (A-FLT), enhanced observed time difference (E-OTD), observed time difference of arrival (OTDOA), and so on. The network-based mode may utilize various positioning methods such as uplink time of arrival (U-TOA); uplink time difference of arrival (U-TDOA), cell-ID, enhanced cell-ID, and so on. Multiple positioning methods for one or more positioning modes may also be employed in combination. The GPS and A-GPS methods derive a location estimate for a mobile station based solely on satellite measurements and have high accuracy. The hybrid method derives a location estimate based on both satellite and base station measurements and has high accuracy and high reliability. The A-FLT, E-OTD, and OTDOA methods derive a location estimate based on measurements of base station timing made by the UE and have more intermediate accuracy. The U-TOA and U-TDOA methods derive a location estimate based on measurements of UE timing made by the serving network and have more intermediate accuracy. The cell-ID and enhanced cell-ID methods derive a location estimate based on a cellular network and have coarser accuracy. These various positioning methods are known in the art.

The method and apparatus herein includes a positioning key operable by the user, as part of a user interface keypad of the mobile station. As an example, the positioning key can initiate display of a location menu whereby the user may select to view current position, a history of positions, notifications of position to external entities, positioning settings, and/or initiate location based applications that the device may be configured to operate.

Additionally, positioning applications are made available to the user, through use of the positioning key, within other applications operable on the device. These other applications can include but are not limited to a browser, mail, contact list or phone book, photography, and favorite locations. The advantage of pressing the positioning key is that the user quickly retrieves location information, such as but not limited to maps, directions, linkage to navigation, and other location based information while operating within another application. The positioning key can also be used for initiating import/export functions of location data. By combining information known to the mobile station, such as but not limited to date, time, user preferences, contact list, etc., with information gained from an application in progress, such as but not limited to an Internet web page, e-mail message, photograph application, or information directly input by the user, the user is presented an intelligent list of location-based options. The embodiments set forth herein are not meant to limit the scope of the method and apparatus but rather to demonstrate its applicability.

In an embodiment, selecting the positioning key causes the mobile station to determine its location, if not recently determined, and provide intelligent options to the user taking into account the location of the user, the day of the week, time of day, and certain user preferences. For example, the user may be prompted of a traffic delay in the user's usual route to work at that time of day and day of week, or the user may be prompted to input an address so that the mobile station can display a map or provide navigation instructions from the current, known, position to the input address.

In another embodiment, selecting the positioning key prompts the user whether they want to navigate to an address contained within an email message or other type of message. As another example, the positioning key offers the user navigation instructions or a map to the physical location of the entity, such as a retail store, described in a web page that the user is viewing in a browser. Alternatively, the user can be presented the option of saving the address, map, or directions to the entity in the mobile station contact list or phone book, or adding it to the user's favorite locations.

The positioning key further supports sending location information via short messaging services (SMS) or multimedia messaging services (MMS). As with browser and mail applications described above, this function includes providing direct linkage to navigation instructions or mapping to or from an SMS/MMS, and adding or storing the location information in contact list, phone book, favorite location or other memory-based application.

While operating the mobile station phone book, address book, contact list, or the like (referred to here generically as an “address book”), the positioning key supports the options of importing or exporting location information from or to the address book, editing or updating the location information in the address book, displaying maps or navigation information via the address book, sending location information by mail (email, SMS, MMS, etc.) from the address book, and adding location information to a favorites list. Additionally, the address book may be ordered via the positioning key. In this option the location information related to each entry is used as the primary filter by which the entries are sorted. For example, knowing the current location of the mobile station, the user can view the address book with entries listed in order of distance to the user's location.

In conjunction with the Third Generation Partnership Project (3GPP) “push-to-talk” over cellular (“PoC”) feature of some mobile stations, the positioning key supports proximity indicator of another mobile station. It also supports the option of transmitting the user's location information, assuming privacy conditions are met, when a PoC call is originated. Further, the positioning key supports the receiving mobile station responding with its location, again assuming privacy conditions are met, when receiving a PoC call.

Buddy list options are supported by the positioning key, such as but not limited to, ordering the list by location, such as proximity to the user, direct linkage to navigation instructions or maps from the buddy list—such as to or from a particular member of the list, direct linkage to a PoC call to a buddy group or individual based upon location—such as within a defined perimeter, and direct linkage to SMS/MMS a buddy group or member based upon location.

In connection with the mobile station's current position (“my position”), the user can import and export location information from or to “my position”, edit the location information related to “my position”, display a map or location information via “my position”, send the information by mail from “my position”, add location information to a favorite location, and refresh “my position” either manually, when idle, when making a call, taking a photograph, sending a SMS/MMS, etc.

In the calendar application that is commonly implemented on many mobile stations, the positioning key can again provide direct linkage to maps and navigation information from the calendar, such as a meeting location, intelligent alerts which alert the user to a meeting based on location and the time it will take to get to the meeting location—which can be enhanced based on knowledge of transportation type and traffic, sending current position or directions to other attendees, and add a meeting location to favorite locations.

The positioning key is integrated with the photograph application as well by acquiring the location information when a built-in camera is being used; storing location information with pictures; adding the location information to favorite locations when viewing a picture/mms/email (with stored location information). It is also possible to: provide direct linkage to navigation (drive to/walk to) where you can set the photograph location as the destination (default) or starting point; adding the location information to favorite locations; displaying the map for the location information in the photo; sending the photo and map/direction/location information by sms/mms or mail.

When in the favorite locations application, the user is provided direct linkage to navigation information where the location is set as the destination (default) or starting point; direct linkage to map the location from favorite locations; storing of the favorite locations to navigate to; acquiring/editing the location information in the favorite locations; and sending the map/direction/location information by sms/mms or mail from the favorite locations. These same options are offered from the position history application as well.

User preferences or parameters are input by the user and include geofencing parameters, typical schedule, default options, and the like.

The techniques described herein may be implemented by various means. For example, the techniques may be implemented in hardware, software, or a combination thereof. For a hardware implementation, the units used to perform the processing at each entity may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a software implementation, the techniques may be implemented with modules (e.g., procedures, functions, and so on) that perform the functions described herein. The software codes may be stored in a memory unit (e.g., memory unit 208, of FIG. 2) and executed by a processor. The memory unit may be implemented within the processor or external to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of providing location information, comprising:
determining a mobile station location;
retrieving information from a mobile station-based application related to location; and
presenting an intelligent location information option to the mobile station user based upon the mobile station location and the information retrieved from the mobile station-based application.

2. An mobile station for providing location information to a user comprising:
means for determining a mobile station location;
means for retrieving information from a mobile station-based application related to location; and
means for presenting an intelligent location information option to the mobile station user based upon the mobile station location and the information retrieved from the mobile station-based application.
